(19) United States
(12) Patent Application Publication
(10) Pub. No.: US 2020/0161024 A1
(43) Pub. Date: May 21, 2020

(54) FLEXIBLE FLAT CABLE STRUCTURE

(71) Applicant: BizLink International Corp., New Taipei City (TW)

(72) Inventors: Hsin-Tuan HSIAO, New Taipei City (TW); Chih-Feng CHENG, New Taipei City (TW)

(21) Appl. No.: 16/446,650

(22) Filed: Jun. 20, 2019

(30) Foreign Application Priority Data
Nov. 21, 2018 (TW) 107215824

(51) Int. Cl. H01B 11/10; H01B 11/18

(52) U.S. Cl. CPC H01B 11/1083; H01B 11/1878

(57) ABSTRACT

A flexible flat cable structure includes a conductor layer, a first low-k dielectric and impedance adjusting adhesive layer, a first metal isolation layer, a second low-k dielectric and impedance adjusting adhesive layer, and a second metal isolation layer. The first low-k dielectric and impedance adjusting adhesive layer is adhered to one side of the conductor layer, the first metal isolation layer is adhered to a surface of the first low-k dielectric and impedance adjusting adhesive layer, the second low-k dielectric and impedance adjusting adhesive layer is adhered to another side of the conductor layer, and the second metal isolation layer is adhered to a surface of the second low-k dielectric and impedance adjusting adhesive layer so as to adjust the impedance of the flexible flat cable structure according to requirements and reduce the electromagnetic interference thereof.

### RELATED APPLICATIONS

This application claims priority to Taiwan Application Serial Number 107215824, filed Nov. 21, 2018, which is herein incorporated by reference.

### TECHNICAL FIELD

The present disclosure generally relates to a flexible flat cable structure. More particularly, the present disclosure relates to a high frequency flexible flat cable structure.

### BACKGROUND

With the development and innovation of various high frequency electronic products, new high frequency electronic products require relatively more bandwidth. Therefore, the world today relies on the rapid and reliable information transmission.

As semiconductors continue to break through in technology, the semiconductors have been widely used in the computer bus architecture, network infrastructure, and digital wireless communication. In the computer industry, especially when the speed of the server computer processor has been upgraded to gigahertz (GHz), the memory transmission rate and the internal bus speed are also apparently increased. High-speed data transmission technology can support more powerful computer applications such as 3D games and computer-aided design programs. Advanced 3D images require a large amount of data transmission in the CPU, memory, and display card.

In addition, because the volume of the new electronic products is getting smaller and smaller, the circuit board design for the new electronic products will be divided into several smaller circuit boards. It can save the design cost of the circuit board, and the shape of the new electronic products can be more flexible.

Among different circuit boards, it is necessary to connect through cables to transmit various electronic signals. A flexible cable has the characteristics of space saving and convenient assembly, and has been widely used in various small-sized electronic devices in recent years. However, some cables are very weak against electromagnetic interference so as to affect the stability of the electronic devices.

### SUMMARY

One objective of the embodiments of the present invention is to provide a flexible flat cable structure to reduce the electromagnetic interference and improve the shielding capacity for shielding the external noise.

To achieve these and other advantages and in accordance with the objective of the embodiments of the present invention, as the embodiment broadly describes herein, the embodiments of the present invention provides a flexible flat cable structure including a conductor layer, a first low-k dielectric and impedance adjusting adhesive layer and a first metal isolation layer.

The first low-k dielectric and impedance adjusting adhesive layer is adhered to one side of the conductor layer, and a first metal isolation layer is adhered to a surface of the first low-k dielectric and impedance adjusting adhesive layer.

In some embodiments, the flexible flat cable structure further includes a second low-k dielectric and impedance adjusting adhesive layer adhered to another side of the conductor layer, and a second metal isolation layer adhered to a surface of the second low-k dielectric and impedance adjusting adhesive layer.

In some embodiments, the conductor layer includes a plurality of conducting metal wires and an insulation layer surrounding the conducting metal wires.

In some embodiments, a dielectric constant of the first low-k dielectric and impedance adjusting adhesive layer and a dielectric constant of the second low-k dielectric and impedance adjusting adhesive layer are about 2 to 4.

In some embodiments, a thickness of the first low-k dielectric and impedance adjusting adhesive layer and a thickness of the second low-k dielectric and impedance adjusting adhesive layer are about 0.1 mm to 1 mm.

In some embodiments, the insulation layer is an epoxy resin insulation layer, a polyester insulation layer or a polyamine insulation layer.

In some embodiments, the first low-k dielectric and impedance adjusting adhesive layer is directly adhered to the conductor layer and the first metal isolation layer.

In some embodiments, the second low-k dielectric and impedance adjusting adhesive layer is directly adhered to the conductor layer and the second metal isolation layer.

In some embodiments, a thickness of the first low-k dielectric and impedance adjusting adhesive layer is different from a thickness of the second low-k dielectric and impedance adjusting adhesive layer.

In some embodiments, a thickness of the first low-k dielectric and impedance adjusting adhesive layer is the same as a thickness of the second low-k dielectric and impedance adjusting adhesive layer.

Hence, the flexible flat cable structure can not only adhere the metal isolation layer and the conductor layer by the low-k dielectric and impedance adjusting adhesive layer, but also utilize the low-k dielectric and impedance adjusting adhesive layer to adjust the impedance of the flexible flat cable, and reduce the electromagnetic interference by using the metal isolation layer to improve the shielding effect of the electromagnetic interference and effectively shield the external noise so as to effectively increase the quality and speed of the high frequency signal transmission and save the processes for manufacturing the flexible flat cable. Therefore, a high frequency signal transmission for a flexible flat cable can be effectively achieved.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a schematic diagram showing a flexible flat cable structure according to one embodiment of the present invention.

### DETAILED DESCRIPTION OF THE PREFERRED EMBODIMENT

The following description is of the best presently contemplated mode of carrying out the present disclosure. This description is not to be taken in a limiting sense but is made merely for the purpose of describing the general principles of the invention. The scope of the invention should be determined by referencing the appended claims.

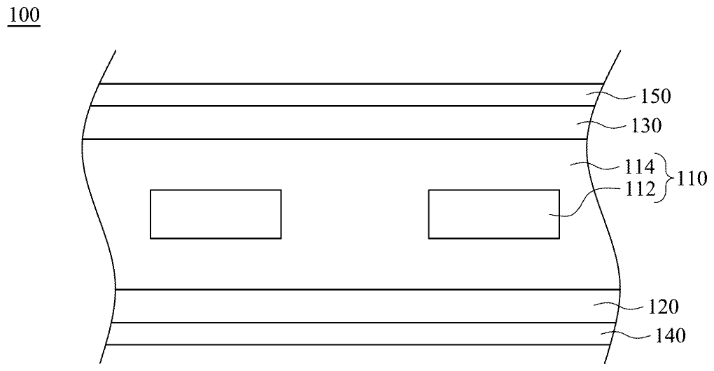

FIG. 1 illustrates a schematic diagram showing a flexible flat cable structure according to one embodiment of the present invention.

As shown in FIG. 1, a flexible flat cable structure 100 includes a conductor layer 110, a first low-k dielectric and impedance adjusting adhesive layer 120, a first metal isolation layer 140, a second low-k dielectric and impedance adjusting adhesive layer 130 and a second metal isolation layer 150.

The first low-k dielectric and impedance adjusting adhesive layer 120 is adhered to one side of the conductor layer 110. The first metal isolation layer 140 is adhered on a surface of the first low-k dielectric and impedance adjusting adhesive layer 120. Therefore, only the first low-k dielectric and impedance adjusting adhesive layer 120 is required to firmly adhere the conductor layer 110 to the first metal isolation layer 140.

The second low-k dielectric and impedance adjusting adhesive layer 130 is adhered to another side of the conductor layer 110. The second metal isolation layer 150 is adhered on a surface of the low-k dielectric and impedance adjusting adhesive layer 130. Therefore, only the second low-k dielectric and impedance adjusting adhesive layer 130 is required to firmly adhere the conductor layer 110 to the second metal isolation layer 150.

In some embodiments, as shown in the drawing, the first low-k dielectric and impedance adjusting adhesive layer 120 is directly adhered to the surface of the conductor layer 110 and the surface of the first metal isolation layer 140. The second low-k dielectric and impedance adjusting adhesive layer 130 is directly adhered to the surface of the conductor layer 110 and the surface of the second metal isolation layer 150.

In some embodiments, the conductor layer 110 includes a plurality of conducting metal wires 112 and an insulation layer 114 surrounding the conducting metal wires 112.

In some embodiments, the dielectric constant of the first low-k dielectric and impedance adjusting adhesive layer 120 and the dielectric constant of the second low-k dielectric and impedance adjusting adhesive layer 130 are about 2 to 4 respectively.

In some embodiments, the thickness of the first low-k dielectric and impedance adjusting adhesive layer 120 and the thickness of the second low-k dielectric and impedance adjusting adhesive layer 130 are about 0.1 mm to 1 mm respectively.

Hence, the impedance of the flexible flat cable structure 100 can be adjusted by controlling the thickness and the dielectric constant of the first low-k dielectric and impedance adjusting adhesive layer 120 and the second low-k dielectric and impedance adjusting adhesive layer 130 so as to improve the signal transmission quality of the flexible flat cable structure 100. It is worth noting that the problems of the signal integrity (SI) and signal reflection can be improved to effectively increase the transmission quality of the signal, especially while transmitting the high frequency signals, e.g. 5 GHz (gigahertz) signals or above, by adjusting the impedance of the flexible flat cable.

In some embodiments, the impedance of the flexible flat cable structure 100 can be further adjusted by adjusting the thickness of the low-k dielectric and impedance adjusting adhesive layer. Hence, the thickness of the first low-k dielectric and impedance adjusting adhesive layer 120 can be different from the thickness of the second low-k dielectric and impedance adjusting adhesive layer 130 to further control the impedance of the flexible flat cable structure 100 as required.

In some embodiments, the thickness of the first low-k dielectric and impedance adjusting adhesive layer 120 can be the same as the thickness of the second low-k dielectric and impedance adjusting adhesive layer 130 to control the impedance of the flexible flat cable structure 100 as required.

In some embodiments, the insulation layer 114 is selected from the group consisting essentially of the epoxy resin, the polyester, the polyamine and the derivatives thereof to form an epoxy resin insulation layer, a polyester insulation layer, a polyamine insulation layer, or the like.

In addition, the first metal isolation layer 140 and the second metal isolation layer 150 can effectively improve the shielding effect of the electromagnetic interference, and can further shield the external noise so as to enhance the quality of the signal transmission.

Accordingly, the flexible flat cable structure can not only adhere to the metal isolation layer and the conductor layer by the low-k dielectric and impedance adjusting adhesive layer, but also utilize the low-k dielectric and impedance adjusting adhesive layer to adjust the impedance of the flexible flat cable, and reduce the electromagnetic interference by using the metal isolation layer to improve the shielding effect of the electromagnetic interference and effectively shield the external noise so as to effectively increase the quality and speed of the high-frequency signal transmission and save the processes for manufacturing the flexible flat cable. Therefore, the flexible flat cable structure can effectively reduce the electromagnetic interference and adjust the impedance thereof without changing the thickness of the insulation layer.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

1. A flexible flat cable structure, comprising:
a conductor layer;
a first low-k dielectric and impedance adjusting adhesive layer adhered to one side of the conductor layer;
a first metal isolation layer adhered to a surface of the first low-k dielectric and impedance adjusting adhesive layer;
a second low-k dielectric and impedance adjusting adhesive layer adhered to another side of the conductor layer; and
a second metal isolation layer adhered to a surface of the second low-k dielectric and impedance adjusting adhesive layer, wherein a thickness of the first, low-k dielectric and impedance adjusting adhesive layer and a thickness of the second low-k dielectric and impedance adjusting adhesive layer are about 0.1 mm to 1 mm, the first low-k dielectric and impedance adjusting adhesive layer is directly adhered to the conductor layer and the first metal isolation layer, and the second low-k dielectric and impedance adjusting adhesive layer is directly adhered to the conductor layer and the second metal isolation layer, wherein the first metal isolation layer and the second metal isolation layer reduce the electromagnetic interference, and the first low-k dielectric and impedance adjusting adhesive layer and the second low-k dielectric and impedance adjusting adhesive layer adjust the impedance of the flexible flat cable structure.

2. (canceled).

3. The flexible flat cable structure of claim 1, wherein the conductor layer comprises a plurality of conducting metal wires and an insulation layer surrounding the conducting metal wires.

4. The flexible flat cable structure of claim 3, wherein a dielectric constant of the first low-k dielectric and impedance adjusting adhesive layer and a dielectric constant of the second low-k dielectric and impedance adjusting adhesive layer are about 2 to 4.

5. (canceled).

6. The flexible flat cable structure of claim 3, wherein the insulation layer is an epoxy resin insulation layer, a polyester insulation layer or a polyamine insulation layer.

7. (canceled).

8. The flexible flat cable structure of claim 1, wherein the second low-k dielectric and impedance adjusting adhesive layer is directly adhered to the conductor layer and the second metal isolation layer.

9. (canceled).

10. The flexible flat cable structure of claim 1, wherein a thickness of the first low-k dielectric and impedance adjusting adhesive layer is the same as a thickness of the second low-k dielectric and impedance adjusting adhesive layer.
